(19) United States
(12) Patent Application Publication
(10) Pub. No.: US 2002/0113699 A1
(43) Pub. Date: Aug. 22, 2002

(54) System for detecting intruders in large areas

(76) Inventors: Alex Pakhomov, Ardsley, NY (US); Tim Goldburt, Chappaqua, NY (US)

Correspondence Address: Ilya Zborovsky, 6 Schoolhouse Way, Dix Hills, NY, 11748, US

(21) Appl. No.: 09/788,236

(22) Filed: Feb. 16, 2001

(51) Int. Cl. G08B 13/00

(52) U.S. Cl. 340/541; 340/540

(57) ABSTRACT

A system for detecting of an intruder has a plurality of sensors distributed over an area of a corresponding area; a process or arranged to process signals obtained from said sensors as a result of activity of the intruder; and the sensors with the processor, the connections are formed so that the sensors are connected parallel with one another to the processor.

### BACKGROUND OF THE INVENTION

The present invention relates to systems for detecting of intruders.

The systems of the above general type are known in the art. It is advisable in the systems for detecting intruders in a predetermined area, to provide a plurality of sensors. The sensors, in response to detecting an intruder, produce corresponding signals, which are received and analyzed by processing means to alert to the presence of the intruder. It is believed that the existing systems can be further improved.

### SUMMARY OF THE INVENTION

Accordingly, it is an object of the present invention to provide a system for detecting an intruder which is a further improvement of the existing systems.

In keeping with these objects and with others which will become apparent hereinafter, one feature of present invention resides, briefly stated, in a system for detecting of an intruder, which comprises a plurality of sensors distributed over a corresponding area; a processing means arranged to process signals obtained from the sensors as a result of activity of the intruder; and means for connecting said sensors with said processing means, said connecting means being formed so that said sensors are connected parallel with one another to said processing means.

When the system is designed in accordance with the present invention, it is possible with a signal processing means, to process the signals from a plurality of sensors. It is however not necessary to have a processing means for each individual sensor, and it suffices to have only one signal processing means for all sensors. It is to be understood that it is therefore possible to provide a great number of sensors all over the area, with this approach.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing an area provided with a plurality of sensors for detecting an intruder; and

FIG. 2 is a schematic view schematically showing the system for detecting the intruder.

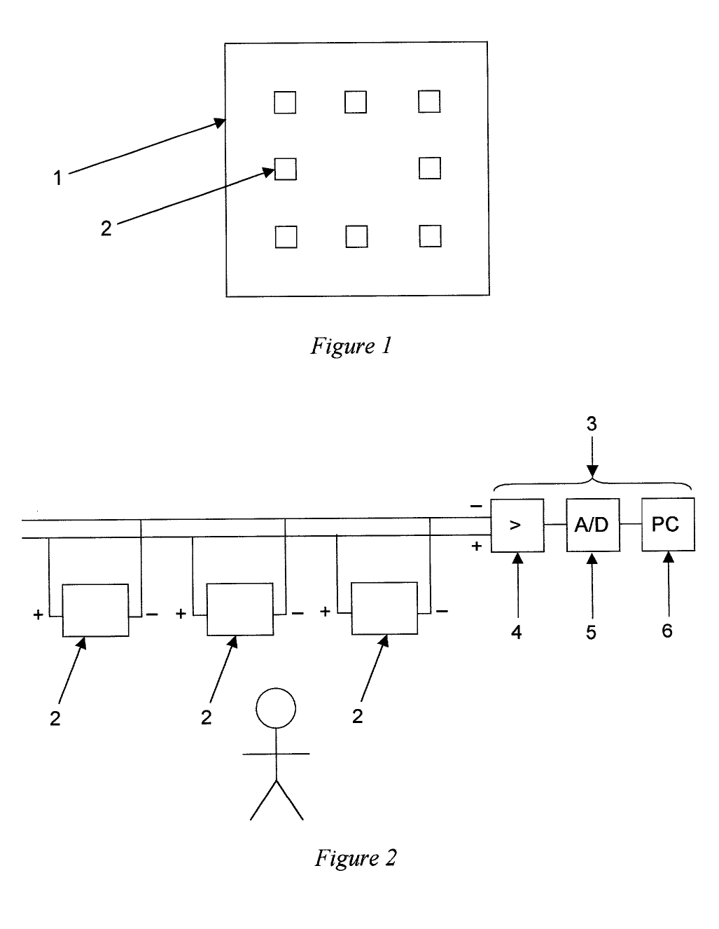

### DESCRIPTION OF PREFERRED EMBODIMENT

In accordance with the present invention, an area which is identified as a whole with reference numeral 1 is provided with a plurality of sensors which are identified with reference numeral 2. The sensors 2 can be of a seismic type, an acoustic type, or a combined seismic-acoustic type, etc.

In accordance with the present invention the system is provided with signal processing means which are identified as a whole with reference numeral 3. The sensors 2 which are arranged at different locations of the area 1 are connected with the processing means 3. In accordance with the important inventive feature of the present invention, the sensors 2 are connected parallel with one another to the signal processing means.

In particular, as can be seen in the drawings, all positive poles of the sensors 2 are connected with one line, and all negative poles of the sensors 2 are connected with another line. The lines lead to the signal processing means.

The signal processing means can include an amplifier 4 connected with the lines, an analog/digital converter 5 connected to the amplifier, and a processor 6 connected with the analog/digital convertor. The processor can be formed as a microcontroller, as a personal computer, etc.

In the inventive system when an intruder identified with reference numeral 7 approaches any of the sensors, the signal of the sensor which can be a voltage, is supplied to the processing unit 3, it is amplified, converted into a digital signal and processed in the processor 6. The processing can be performed for example as in our copending application serial number _______, to determine presence or absence of the intruder.

It is believed to be clear that it does not matter which sensor 2 is approached by the intruder 7. In any case the system will produce the signal identifying the intruder. The signal can be supplied also to an alarm system, which can be formed as an audio, video, or audio/video alarm system.

It will be understood that each of the elements described above, or two or more together, may also find a useful application in other types of constructions differing from the types described above.

While the invention has been illustrated and described as embodied in system for detecting an intruder, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A system for detecting of an intruder, comprising a plurality of sensors distributed over a corresponding area; a processing means arranged to process signals obtained from said sensors as a result of activity of the intruder; and means for connecting said sensors with said processing means, said connecting means being formed so that said sensors are connected parallel with one another to said processing means.

2. A system as defined in claim 1, wherein said processing means include signal amplification means and computing means connected with said amplification means.

3. A system as defined in claim 1; and further comprising an analog-digital converting means provided between said signal amplification means and said computing means.
